(19) United States
(12) Patent Application Publication
(10) Pub. No.: US 2009/0217445 A1
(43) Pub. Date: Sep. 3, 2009

(54) Method and apparatus for hygienic flush toilets

(76) Inventors: Hoang Van Nguyen, San Jose, CA (US); Ngoc Anh Mai, San Jose, CA (US)

Correspondence Address: HOANG VAN NGUYEN, 1273 ALVERNAZ DR., SAN JOSE, CA, 95121, US

(21) Appl. No.: 12/072,768

(22) Filed: Feb. 28, 2008

(51) Int. Cl. E03D 9/00; B08B 3/04; E03D 11/00

(52) U.S. Cl. 4/300; 4/223; 134/18

(57) ABSTRACT

A hygienic plug-in unit that is adapted to a flush toilet system is disclosed that includes a first chamber, a second chamber, and a third chamber all connected together. In the first chamber, water is intake and distributed into the other chambers by the refilling mechanism. In the second chamber, a sensor is electrically coupled to an atomizer. In the third chamber, a detergent and deodorizing substance is stored. When a user is detected by the sensor, the sensor activates the atomizer device to release the cleansing and deodorizing substance in form of a mist into a toilet bowl located below.

### FIELD OF THE INVENTION

The present invention relates generally to the field of home fixtures. More particularly, the present invention relates to the field of development of hygienic flush toilets.

### BACKGROUND

Homeowners or apartment dwellers use flush toilet almost every day. This makes the flush toilet one of the most important fixtures in their home. Flush toilet also presents the most hygienic problems because human wastes are a source of unhealthy bacteria. Furthermore, human wastes combined with water are a common corrosive substance to a toilet bowl. Thus, it is important to maintain a clean and sanitary flush toilet, which can be a daunting task. If not cleaned properly, a toilet bowl can threaten our health and cause discomfort to users and devalue the home price. Thus, there are needs for a flush toilet that can automatically and thoroughly clean itself, hide the unpleasant sight of human's solid waste, and provide pleasant smell to the users during use.

Now referring to FIG. 1, a side view of a prior art flush toilet 100 is illustrated. Flush toilet 100 is bolted down to a bathroom floor 120 and leaned against a bathroom wall 121. Flush toilet 100 includes a toilet bowl 101 connected to a water tank 104 via a spud 107. Toilet bowl 101 further includes a seat 102 and a cover 103. Cover 103 and seat 102 are mounted to toilet bowl 101 by means of screws 109. Water tank 104 is covered by a lid 106 and includes a handle 105. Handle 105 is connected to a flushing mechanical system (not shown) installed inside tank 104 which also contains a refilling mechanical system (not shown). Water tank 104 usually contains about two gallons of water 131 supplied via a water pipe 108 that is connected with other water pipes (not shown) hidden inside bathroom wall 121.

The operation of conventional flush toilet 100 described above is well known in the art. Generally, after a user has finished using flush toilet 100, she activates handle 105 to cause water 131 to rush down to toilet bowl 101 via spud 107, thus creating a siphoning effect to wash human wastes 132 down the drainage system of the house. After the flush mechanical system of flush toilet 100 has finished, the refill mechanical system is automatically triggered to allow water 131 to flow back into tank 104.

However, during usage, toilet bowl 101 contains water 131 and does not hide the sight of human wastes 132, which can be unpleasant to human eyes and can cause discomfort to a user. Furthermore, even though the water 131 inside toilet bowl 101 traps some of the odors inside, some of the odors may still escape and offend the user. In addition, during unused time, the inner wall of toilet bowl 101 is usually dry and can be easily corroded by the residue of human waste 132. This may be a source of unhealthy bacteria that threaten our health. As a consequence, users regularly spend time, efforts, and money to maintain a clean and sanitary flush toilet 101.

Thus, there is an unmet need for a flush toilet that can hide the sight of human wastes and provide detergent as well as aromatic solutions to user during the use of a toilet bowl. Furthermore, there is an unmet need for a flush toilet that may clean itself during unused time, resulting in a hygienic flush toilet without taints and ugly corrosions. Thus, there is an unmet need for a flush toilet that can maintain itself clean and hygienic without spending time, money, and effort. In addition, there is an unmet need for a flush toilet that is inexpensive and easy to use. The current invention meets these above needs.

### SUMMARY OF THE INVENTION

A hygienic plug-in unit that is connected to a flush toilet system is disclosed that includes a first chamber, a second chamber, and a third chamber all water connected together to allow water to flow freely between them. That is, in the first chamber, water is received and distributed into the other chambers by a refill mechanical system. In the second chamber contains a sensor which is electrically coupled to an atomizer. In the third chamber, a cleansing and deodorizing substance is stored. When a user is detected by the sensor, the sensor activates the atomizer to release the cleansing and deodorizing substance in form of a mist into a toilet bowl located below, thus hiding human wastes from view, deodorizing the toilet bowl, and keeping away corrosive particles from clinging onto the inner wall of the toilet bowl. In one embodiment, the hygienic plug-in unit also contains a timer electrically connected to the atomizer so that user can set automatic release of the cleansing and deodorizing and misty mixture down to the toilet bowl.

A method of maintaining a flush toilet is disclosed that includes the steps of sensing a user; releasing a cleansing and deodorizing misty mixture into toilet bowl when a user is detected; if a user is not detected, determining whether a timer for the atomizer is set. If the timer is set, release the mixture into toilet bowl and operates the flush toilet according to the time period set by the timer. Finally, if timer is not set, continue to detect a user.

The above and still further objects, features and advantages of the present invention will become apparent upon consideration of the following detailed description of several specific embodiments thereof, especially when taken in conjunction with the accompanying drawings.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 illustrates a side view of a prior art flush toilet that is mounted on a bathroom floor and a bathroom wall.

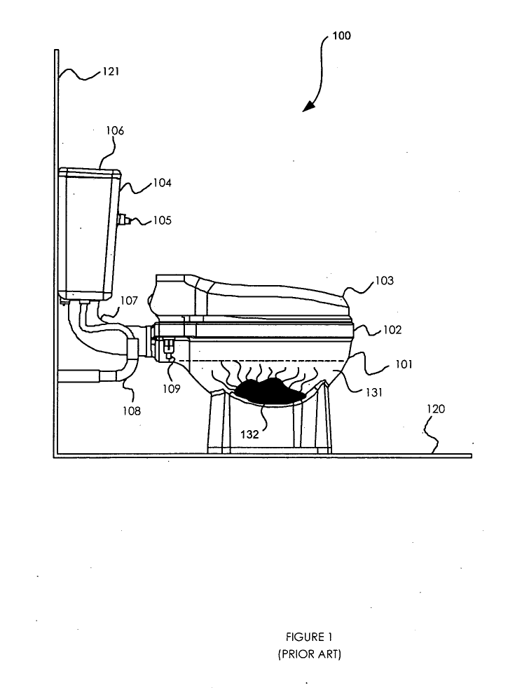

FIG. 2A illustrates a side view of a flush toilet that includes a hygienic plug-in unit that senses a user and releases a misty mixture of a cleansing and deodorizing substance to a toilet bowl in accordance with an embodiment of the present invention.

FIG. 2B illustrates a front view of a flush toilet equipped with a hygienic plug-in unit in accordance with an embodiment with the present invention.

FIG. 3 illustrates a side view of a hygienic plug-in unit that is mounted to a flush toilet to improve the hygiene and the

FIG. 4 illustrates a top plan view of an internal structure of a hygienic plug-in unit of FIG. 3 that includes a first chamber, a second chamber, and a third chamber that are connected together and filled up with water from the toilet water tank in accordance with an embodiment with the present invention.

FIG. 5 illustrates the manner the hygienic plug-in unit is mounted onto a flush toilet bowl in accordance with an embodiment of the present invention.

FIG. 6 illustrates a simplified top view a second compartment that contains a sensor electrically connected to an atomizer and an electrical cord of the hygienic plug-in unit in accordance with an embodiment of the present invention.

FIG. 7 illustrates the floor plan and the direction of water flow inside the hygienic plug-in unit in accordance with an embodiment with the present invention.

FIG. 8 illustrates a flow chart of a process of maintaining a flush toilet in accordance with an embodiment of the present invention.

### DETAILED DESCRIPTION OF THE INVENTION

Reference will now be made in detail to different embodiments of the invention, examples of which are illustrated in the accompanying drawings. While the invention will be described in conjunction with the preferred embodiments, it will be understood that they are not intend to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of the ordinary skill in the art that the present invention may be practiced without these specific details. In other instances, well-known methods, procedures, components, and circuits have not been described in detail so as not to unnecessarily obscure aspects of the present invention.

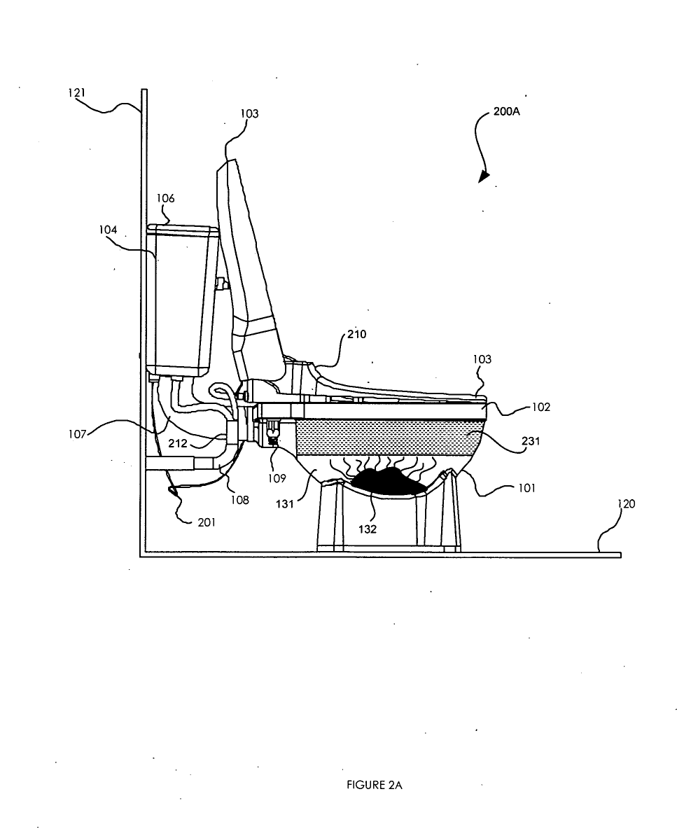

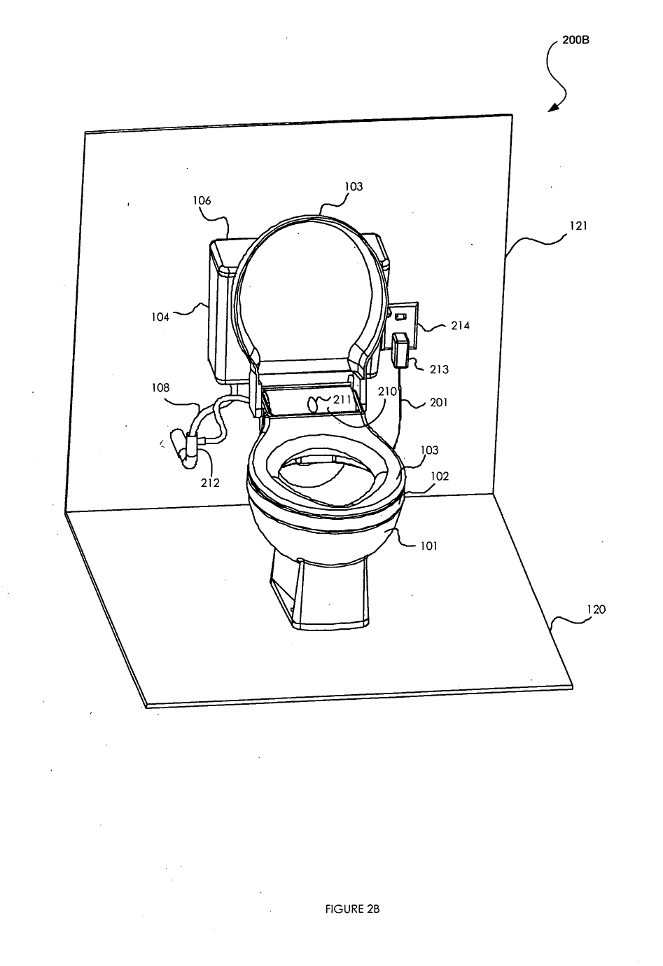

Referring to FIG. 2A, a side view of a flush toilet 200A that includes a hygienic plug-in unit 210 in accordance with an embodiment of the present invention is shown. Hygienic plug-in unit 210 is adapted connect with flush toilet 100 to generate a misty mixture of cleansing and deodorizing substance (hereinafter also referred to as “a misty mixture”) 231 that floats above water 131 and contacts with the inner surface of toilet bowl 101. As such, misty mixture of cleansing and deodorizing substance 231 covers the sight of solid waste 132 from user's view and further blocks bad odors from escaping toilet bowl 101. In addition, misty mixture of cleansing and deodorizing substance 231 carries both deodorizing substance and cleansing substance provides further deodorizing function to the bathroom. Later on, after use, the cleansing substance from misty mixture 231 would cling to the inner wall of toilet bowl 101 to prevent nasty corrosion to toilet bowl 101. In one embodiment, misty mixture of cleansing and deodorizing substance 231 is generated from an atomizer (not shown) mounted inside hygienic plug-in unit 210. A mixture of cleansing and deodorizing substance amixed with water contained inside hygienic plug-in unit 210 would be atomized or turned into misty mixture 231 by the atomizer. In one embodiment, hygienic plug-in unit 210 also includes a timer (not shown) that can cause the atomizer to release misty mixture 231 at a certain time period conveniently set by a user.

Referring now to FIG. 2B, a front view of a flush toilet 200B that includes hygienic plug-in unit 210 discussed above is illustrated. In an embodiment of the present invention, hygienic plug-in unit 210 is mounted behind a user, conveniently between cover 103 and toilet seat 102. A sensor 211 is located in front of hygienic plug-in unit 210 to sense a user. Sensor 211 is powered by a power unit that includes an electric cord 201 electrically coupled to an adapter 213. Adapter 213 is connected to an electrical outlet 214 mounted on bath room wall 121. Hygienic plug-in unit 210 of the present invention includes water that is supplied by a tee 212 that extracts water from water pipe 108.

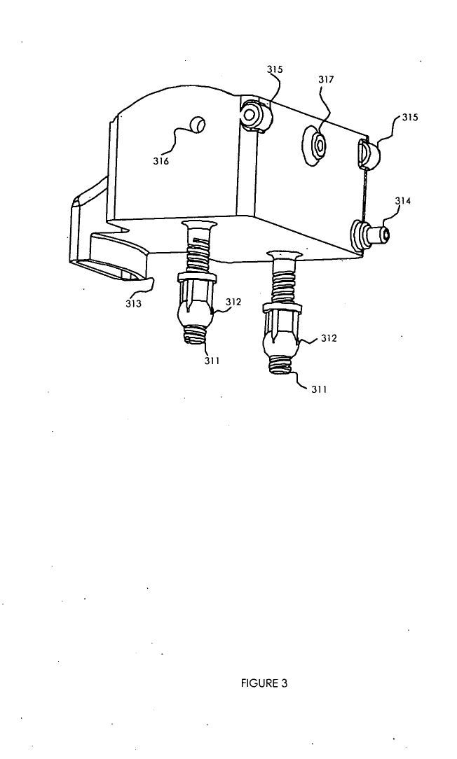

Referring now to FIG. 3, a side view of the exterior of hygienic plug-in unit 210 is illustrated. On the bottom side, hygienic plug-in unit 210 includes mounting bolts 311 separate by the same distance of the mounting bolts of toilet seat 102. Consequently, hygienic plug-in unit 210 is mounted on toilet bowl 101 first instead of toilet seat 102 and cover 103. Nuts 312 are used to secure hygienic plug-in unit 210 to toilet bowl 101. On the back side of hygienic plug-in unit 210, a water inlet orifice 314 is adapted to receive water from tee 212. Water tube, originated from tee 212 plugged in snuggly to water inlet orifice 314, provides water to hygienic plug-in unit 210. An opening 317 enables electrical cord 201 to enter the interior of hygienic plug-in unit 210. Electrical units (not shown) mounted inside hygienic plug-in unit 210 are supplied electrical power via electrical cord 201 that goes through opening 317. Two connectors 315 are engaged with the screws of toilet seat 102 and cover 103 so that hygienic plug-in unit 210 can be installed in flush toilet 200. In the front side of hygienic plug-in unit 210, an outlet 313 points down towards the bottom of toilet bowl 101 so that misty mixture of cleansing and deodorizing substance 231 is released into toilet bowl 101 from hygienic plug-in unit 210.

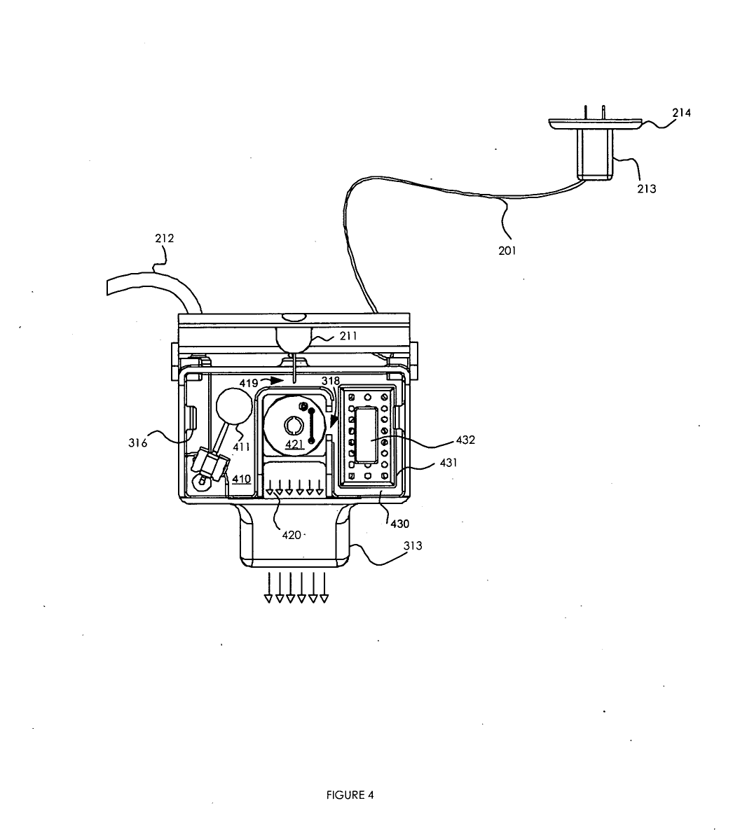

Now referring to FIG. 4, a plain view of the interior of hygienic plug-in unit 210 as described in FIG. 3 is shown. In one embodiment of the present invention, hygienic plug-in unit 210 includes a first chamber 410, a second chamber 420, and a third chamber 430, each having a different function. However, it is understood that hygienic plug-in unit 210 can contain more than three chambers that provide more functions to flush toilet 200. First chamber 410 includes a water intake and refill mechanism that includes water refill and release mechanical systems similar those used in water tank 105 well known in the art. That is, first chamber 410 contains a float ball 411, float arm 412, etc. that intakes water through inlet orifice 314. Second chamber 420 includes a sensor 211 and an atomizer 421 electrically coupled to each other. Once sensor 211 senses a user, it activates atomizer 421 to release misty mixture of cleansing and deodorizing substance 231 towards toilet bowl 101 according to the direction indicated by the arrows. Third chamber 430 includes a container 431 that houses cleansing and detergent substance 432.

In operation, when water level in hygienic plug-in unit 210 is low as it is used up by atomizer 421, float ball 411, which floats on-top of the water in first chamber 410, drops down. This pulls on float arm 412, displacing a valve plunger (not shown) in a ballcock assembly (not shown) and allowing fresh water to flow into first chamber 410 via inlet orifice 314. Water seeps to second chamber 420 and third chamber 430 because they are connected together by back corridor 419. As the water level rises in hygienic plug-in unit 210, float ball 411 rises until float arm 412 is high enough to lower the valve plunger in the ballcock assembly and shut off the incoming water. Next, cleansing and deodorizing substance 432 released from container 431 will be mixed with water. In one embodiment, container 431 also contains other detergent materials. Once sensor 211 senses a user, it activates atomizer 421 to turn mixture of water and detergent into a misty mixture 231. Such misty mixture 231 follows gravity and exit outlet 313 to fill up toilet bowl 101. Misty mixture 231 serves multiple functions once it fills toilet bowl 101. First, it covers toilet bowl 101 so that user cannot see solid waste. Second, it serves as a second layer to block bad odor from escaping toilet bowl 101. Third, it wets the inner wall of toilet bowl 101 so that solid waste will not corrode the inner wall and hidden edges in toilet bowl 101. In one embodiment, hygienic plug-in unit 210 also contains a timer that is activated by user so that atomizer 421 automatically releases misty mixture 231 that covers the inner wall of toilet bowl 101. Thus, with hygienic plug-in unit 210, flush toilet 200 does not have to be manually cleaned up by users, thus saving time, money, and efforts for the users.

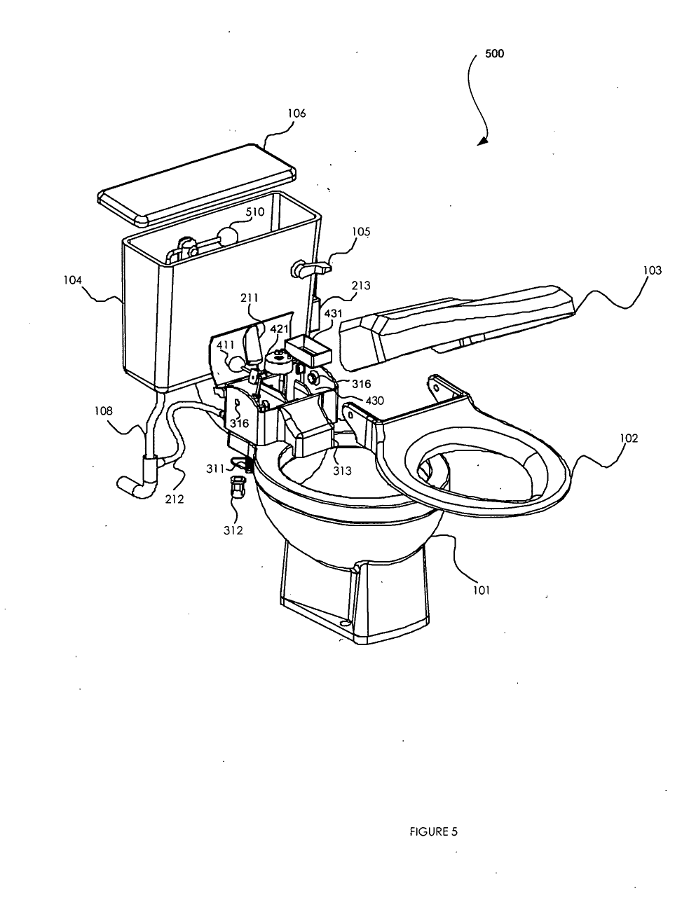

Now referring to FIG. 5, a complete assembling of hygienic plug-in unit 210 into flush toilet system 500 is shown. First, cover 103 and toilet seat 102 are removed from toilet bowl 101. Then, hygienic plug-in unit 210 is inserted into toilet bowl 101 by mounting bolts 311. Washers and nuts 312 are slid into and tightened to secure hygienic plug-in unit 210 onto toilet bowl 101. Finally, toilet seat 102 and cover 103 are plugged in to hygienic plug-in unit on the side adaptors 316.

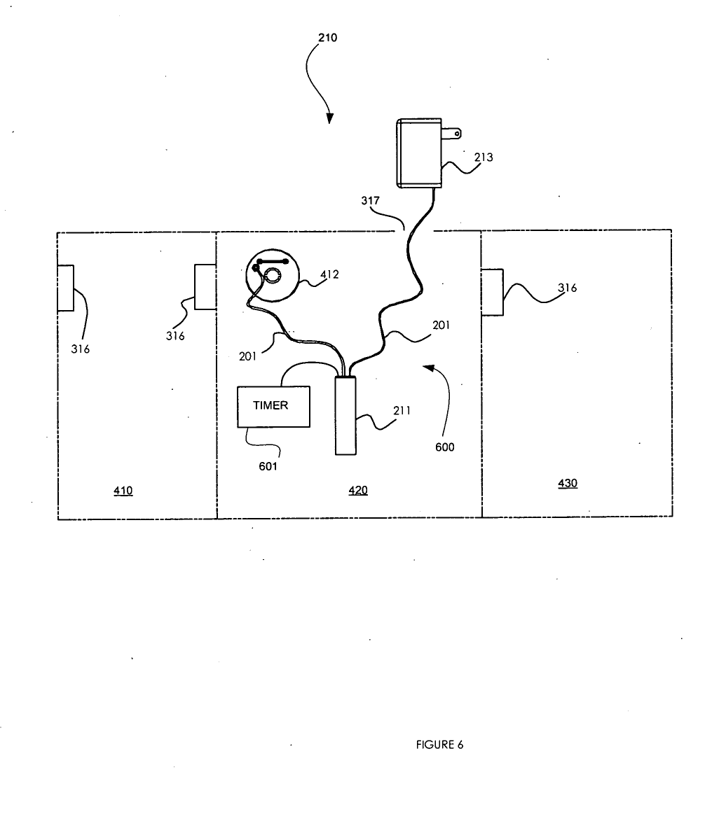

Referring next to FIG. 6, an electrical unit 600 installed in second chamber 420 is shown in accordance with an embodiment of the present invention. Second chamber 420 contains sensor 211 electrically coupled to atomizer 421 via electrical cord 201. Sensor 211 is powered by adaptor 213 at a wall electrical outlet 214. In one embodiment, electrical unit 600 also includes a timer 601 so that users may activate automatic cleaning of toilet bowl 101. Accordingly, hygienic plug-in unit 210 of the present invention allows users to maintain a clean and aromatic flush toilet without manually cleaning.

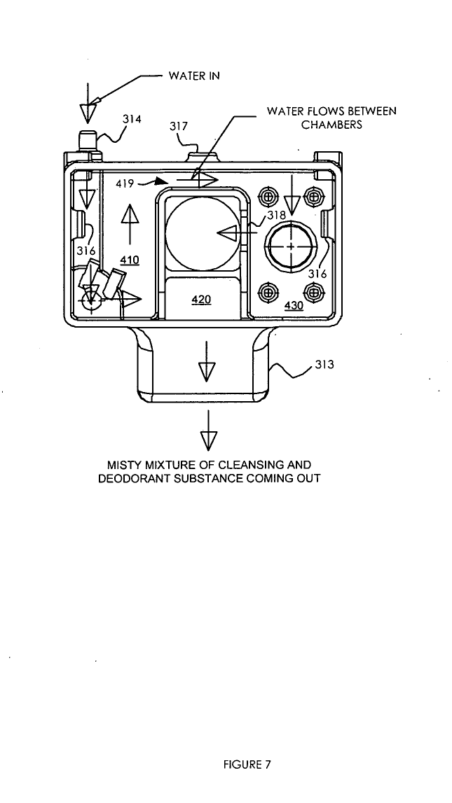

FIG. 7 illustrates the direction of flow and operation of hygienic plug-in unit 210 in accordance with an embodiment of the present invention. First, water is allowed to flow into first chamber 410 via intake orifice 314. Since water seeks its own level, water rushes into second chamber 420 and third chamber 430 via back corridor 419 that connects first chamber 410 with third chamber 430. There, water is mixed with cleansing and deodorizing substance 231 and is led into second chamber 420 where atomizer 421 is located. If a user is detected, sensor 211 located in front of hygienic plug-in unit 210 will activate atomizer 421 to release the mixture in form of mist. Misty mixture of cleansing and deodorizing substance 231 follows the pull of gravity and escapes down toward hygienic plug-in unit 210 via outlet 313 into toilet bowl 101. In one embodiment, atomizer 421 comprises a negative ion atomizing device that creates a swirling mist that fills toilet bowl 101 and then continuously and gently fills over the side of toilet bowl 101 without touching a user. Mist of cleansing and deodorizing substance comprises negatively charged molecules that will attract and cling to positively charged molecules of human waste. As a result, molecules of human wastes cannot attach themselves to the inner wall of toilet bowl 101.

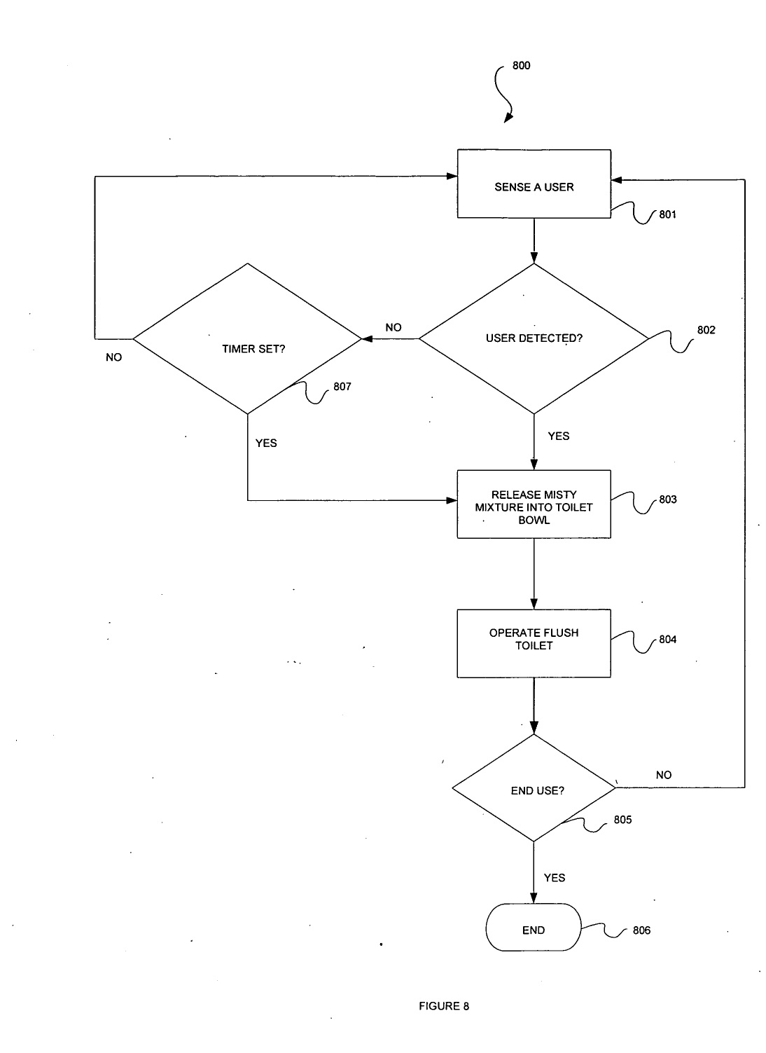

Now referring to FIG. 8, a flow chart 800 showing a method of maintaining a flush toilet is illustrated that includes the steps of sensing a user, if a user is detected, releasing a cleansing and deodorizing mist into toilet bowl and then operate the flush toilet as usual; if an user is not detected, determining whether a timer for the atomizer is set. If the timer is set, release the mixture into toilet bowl and operates the flush toilet according to the time period set by the timer. Finally, if timer is not set, continue to detect a user.

More particularly, at step 801, a user is sensed. This step is implemented by sensor 211 installed in front of hygienic plug-in unit 210 of the present invention. In one embodiment, sensor 211 can be adjusted to scan for a distance less than the length of toilet bowl 101 so that we can avoid detecting the wall of toilet bowl 101 and falsely activating atomizer 421.

Referring to step 802, determining whether a user is detected. Step 802 is implemented by sensor 211. Typically, sensor 211 emits a signal toward the front of toilet bowl 101. If a user sits down toilet seat 102 to use flush toilet 200, the signal is reflected from user and returned to sensor 211, ascertaining that a user is detected.

Referring now to step 803, cleansing and deodorizing mixture in form of mist is released into toilet bowl if a user is detected. The returned signal from step 802 will activate atomizer 421 placed in second chamber 420 of hygienic plug-in unit 210 of the present invention.

Next, referring to step 804, after misty mixture fills up toilet bowl, operate the flush toilet as usual. Step 804 is realized by hygienic plug-in unit 210 installed into flush toilet 100 shown in FIG. 2 and FIG. 5.

Referring now to step 805, determining whether the user has finished using the flush toilet.

Referring next to step 806, if the answer is “yes”, the flush toilet is returned to idle state or non-used state. This step is implemented by sensor 211 determining that no user has been detected for a certain period of time. However, if the user has not finished using the flush toilet, sensor 211 is necessarily detected the user and steps 801 to step 805 are repeated. In one aspect of the present invention, if sensor 211 does not detect a user after a certain period of time, timer 601 determines whether automatic release of misty mixture 231 was set by the user. Thus, method 800 goes to step 807.

Referring to step 807, if a user is not detected, determine whether a timer is set by a user. This step is implemented by a timer installed in second chamber 420. Timer is electrically coupled to both atomizer 421 and sensor 211. If timer is set, it will temporarily deactivate sensor 211 and activate atomizer 421 in accordance to the time period set by user. Afterwards, step 803 and 804 are repeated.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A flush toilet, comprising:
a toilet bowl;
a water tank coupled to said toilet bowl for providing water to said toilet; and
a hygienic plug-in unit, removably connected to said toilet bowl and said water tank, operable to fill said toilet bowl with a misty mixture of cleansing and deodorizing substance as soon as said hygienic plug-in unit detects a user.

2. The flush toilet of claim 1 wherein said hygienic plug-in unit further comprises a sensor operable to emit a signal to detect said user.

3. The flush toilet of claim 1 wherein said hygienic plug-in unit further comprises an atomizer operable to take water from said hygienic plug-in unit to generate said misty mixture of cleansing and deodorizing substance.

4. The flush toilet of claim 3 wherein said hygienic plug-in unit further includes an AC adapter that takes electrical power from an electrical outlet located on surrounding walls to provide electrical power to said atomizer.

5. The flush toilet of claim 1 wherein said hygienic plug-in unit further comprises:
a first chamber containing water from a water source;
a second chamber for housing said atomizer, said second chamber is connected to said first chamber so as to receive water for said atomizer; and
a third chamber for housing a cleansing and deodorizing unit, said third chamber connected to said first chamber and said second chamber to provide cleansing and deodorizing substance amixed with said water to form a cleansing and deodorizing mixture.

6. The flush toilet of claim 5 wherein said hygienic plug-in unit further comprises means located in front of said hygienic plug-in unit and having a large opening for facilitating the flow said misty mixture of cleansing and deodorizing substance toward said toilet bowl.

7. The flush toilet of claim 6 wherein said hygienic plug-in unit further comprises threaded bolts for conveniently docking with said toilet bowl.

8. The flush toilet of claim 7 wherein said threaded bolts further comprises nuts adapted to engage with said threaded bolts for firmly securing said hygienic plug-in unit to said toilet bowl.

9. The flush toilet of claim 8 wherein said hygienic plug-in unit further comprises openings that receive water from external water supply and facilitate water flowing between said first chamber, said second chamber, and said third chamber.

10. A flush toilet of claim 9 wherein said hygienic plug-in unit is situated between said water tank and said toilet bowl.

11. The flush toilet of claim 10 wherein said first chamber further comprises:
means for supplying water into said hygienic plug-in unit; and
means, mechanically coupled to said water supplying means, for maintaining a constant water level in said hygienic plug-in unit.

12. The flush toilet of claim 11 wherein said hygienic plug-in unit further comprises a timing device, electrically coupled to said atomizer, operable to set a fixed time period for filling said toilet bowl with said misty mixture of cleansing and deodorizing substance.

13. The flush toilet of claim 12 wherein said timing device is set by said user.

14. The flush toilet of claim 13 wherein said hygienic plug-in unit is made of a non-corrosive material.

15. The flush toilet of claim 14 wherein said hygienic plug-in unit further comprises means for securing a cover lid to said toilet bowl.

16. A method of maintaining a hygienic flush toilet, comprising:
detecting for an user;
whenever said user is detected, filling up said toilet bowl to the rim with an misty mixture of cleansing and deodorizing substance; and
whenever said user is not detected, filling up said toilet bowl with said misty mixture of cleansing and deodorizing substance only during a time period set by said user.

17. The method of claim 16 wherein said detecting for a user further comprising sending out a signal and detecting the return of said signal.

18. The method of claim 16 wherein said filling up said toilet bowl further comprises:
receiving water from a water supply source;
mixing said water with a mixture of cleansing and deodorizing substance; and
generating said misty mixture of cleansing and deodorizing substance using an atomizer device.

19. A hygienic plug-in unit for maintaining hygiene for a flush toilet, comprising.
means for detecting a user;
means for generating a misty mixture of cleansing and deodorizing substance that fills up a toilet bowl of said flush toilet upon detection of said user; and
means for automatically generating said aromatic and cleansing mixture at a fixed time period set by said user when usage is not detected.

20. The hygienic plug-in unit of claim 19 wherein said misty mixture of cleansing and deodorizing substance generating means further comprising:
means for generating a water mixed with a cleansing and deodorizing substance; and
means for generating said mixture of cleansing and deodorizing substance in form of a mist.
